(19) United States
(12) Patent Application Publication
(10) Pub. No.: US 2008/0141776 A1
(43) Pub. Date: Jun. 19, 2008

(54) Movable Body Speed Measuring System

(75) Inventor: Toyozo Kato, Tokyo (JP)

Correspondence Address: PILLSBURY WINTHROP SHAW PITTMAN, LLP, P.O. BOX 10500, MCLEAN, VA, 22102, US

(73) Assignee: Nikko Co., Ltd., Tokyo (JP)

(21) Appl. No.: 11/665,696

(22) PCT Filed: Oct. 18, 2004
(86) PCT No.: PCT/JP04/15353

§ 371 Date: Oct. 10, 2007

(51) Int. Cl. G01S 11/14; A63H 30/04

(52) U.S. Cl. 73/602; 446/456

(57) ABSTRACT

There are included a movable body on which an ultrasonic wave signal output part for producing and outputting an ultrasonic wave signal of a particular frequency is mounted; an ultrasonic wave signal reception part for receiving the outputted ultrasonic wave signal; a determination part for determining the difference between the frequency of the ultrasonic wave signal received by the ultrasonic wave signal reception part and the particular frequency; a calculation part for calculating the speed of the movable body from a signal of the determination difference; and a display part for displaying a result of the calculation.

### FIELD OF THE INVENTION

The present invention relates to a movable body speed measuring system which may provide a speed measurement of a movable body moving at low speed with a high precision.

### BACKGROUND OF THE INVENTION

For the purpose of full explanation of the present technical level pertaining to the present invention, every patent, patent application, patent publication, scientific article and so on cited or specified in the present application are all incorporated herein for reference.

The conventional method for measuring a speed of a toy such as a radio control car is generally known as using two sensors. Namely, two light generating devices are arranged in predetermined distance and two light sensors are arranged to receive the respective lights. A car moves interrupting the two lights, thereby a car speed may be measured from the distance between the two lights and the time period from the interruption of the first light to that of the second light. In this method, the two light generating devices should be arranged exactly in the predetermined distance to correctly measure a car speed. A speed precision depends on the measurement precision.

Additionally, the light between the first light generating device and the first light sensor and the light between the second light generating device and the second light sensor should be parallel and the same length.

Further, a car should vertically interrupt the lights. Namely, failure of vertical interruption causes different distance.

Therefore, the mentioned method has issues that improvement of precision is difficult, a considerable man-hour is required to prepare for measurement and measurement equipment becomes large-scale.

Thus, as described in Patent Reference 1, an invention wherein a gate member incorporates a determining means for a movable body is suggested.

In the mentioned invention, the issues that improvement of precision is difficult and a considerable man-hour is required may be solved. However, the issue that measurement equipment becomes large-scale may not be solved. Further, there is an issue that different types of gates are required according to a shape and a speed of the car measured and so on.

On the other hand, a speed gun may be raised as being widely used as a speed measurement equipment. A speed gun transmits electromagnetic wave of SHF band, from which and the reflected wave of a movable body, a speed of the movable body is calculated by means of Doppler Effect. An aspect of this method is a requirement of a speed of a movable body to be a given speed or more. For example, a measurable speed of a movable body is 1 km/h or more but not exceeding 500 km/h. It is difficult to measure a speed less than 1 km/h such as that of a radio control car.

Additionally, a given distance to a movable body is also required. Specifically, a distance from 6 m to 1800 m is required. Therefore, it is difficult to measure a speed at a close distance such as that of a radio control car and an operator.

Further, an object to be measured, if small, preferably has an even surface such as that of a ball. Therefore, mismeasurement may happen in measuring a small object having a complicated surface shape such as that of a radio control car.

Besides, a speed gun radiates electromagnetic wave and reflects the same, for which reason a given output of electromagnetic wave is required. Further, costs of parts are also required.

On the other hand, as show in Patent Reference 2, a speed measuring system wherein a moving speed is calculated by receiving electronic wave from a moving source is suggested. In this method, reflection is not utilized, for which reason the issue that a surface shape of a movable body has an effect may be solved.

However, in the mentioned method, electromagnetic wave is utilized, for which reason the issues of a speed and a distance to be measured may not be sufficiently handled.

[Patent Reference 1] Laid-Open Patent Publication No. H09-325155

### [Patent Reference 2] Laid-Open Patent Publication No. 2000-275334

### DISCLOSURE OF THE INVENTION

### Issue to be Solved by the Invention

The present invention was invented to solve the mentioned issues. It is an object of the present invention to provide a movable body on which an ultrasonic wave signal output part for producing and outputting an ultrasonic wave signal of a particular frequency is mounted; an ultrasonic wave signal reception part for receiving the outputted ultrasonic wave signal; a determination part for determining the difference between the frequency of the ultrasonic wave signal received by the ultrasonic wave signal reception part and the particular frequency; a calculation part for calculating the speed of the movable body from a signal of the determination difference; and a display part for displaying a result of the calculation, thereby a speed of a movable body moving at low speed may be measured with a high precision.

It is a further object of the present invention to provide an ultrasonic wave signal output part for producing and outputting an ultrasonic wave signal of a particular frequency, thereby low speed less than 1 km/h may be easily measured.

In addition, the mentioned ultrasonic wave signal output part is mounted on a movable body, thereby a direct wave is utilized to reduce a load of the output part.

It is a still further object of the present invention to provide an ultrasonic wave signal reception part for receiving the outputted ultrasonic wave signal, thereby a speed may be measured at a close distance.

It is yet a further object of the present invention to provide a determination part for determining the difference between the frequency of the ultrasonic wave signal received by the ultrasonic wave signal reception part and the particular frequency, thereby a speed may be measured with a high precision.

It is a furthermore object of the present invention to provide a calculation part for calculating the speed of the movable body from a signal of the determination difference, thereby a correct speed may be calculated.

It is a still furthermore object of the present invention to provide a display part for displaying a result of the calculation, thereby a speed may easily be notified.

It is yet a furthermore object of the present invention to provide the mentioned ultrasonic wave signal output part comprising an oscillator circuit for transmission to oscillate a signal of the particular frequency, a booster circuit for signal amplification to boost voltage, an ultrasonic wave sensor drive circuit for driving ultrasonic wave sensor by an oscillation signal and the boosted voltage and an ultrasonic transducer, thereby ultrasonic wave having sufficiently large amplification may be generated by a low voltage battery.

It is a still furthermore object of the present invention to provide a plurality of the mentioned oscillator circuits for transmission configured so that any one of the oscillator circuits for transmission may, by selecting means, be selected to be connected to the mentioned ultrasonic wave sensor drive circuit, thereby it is possible to concurrently measure speeds of a plurality of movable bodies moving all together in close proximity.

It is yet a furthermore object of the present invention to provide the mentioned ultrasonic wave signal reception part comprising an ultrasonic wave sensor input part including a receiver comprising an ultrasonic transducer and so on and an amplification part for amplifying a signal from a receiver, thereby a minute ultrasonic wave signal may easily be determined.

It is a still furthermore object of the present invention to provide the mentioned determination part comprising an oscillator circuit part for reception to oscillate a signal of the particular frequency, a frequency difference extraction circuit part mixing a signal of the mentioned particular frequency and a signal amplified at the mentioned amplification part, and a low-pass filter part selectively making a signal of the frequency difference pass through, thereby only the necessary signal of the difference is extracted.

It is yet a furthermore object of the present invention to provide a plurality of the mentioned oscillator circuits for reception configured so that any one of the oscillator circuits for reception may, by selective means, be connected to the mentioned frequency difference extraction circuit part for enabling correspondence to the change of transmit frequency.

It is a still furthermore object of the present invention to provide the mentioned calculation part comprising a sampling part for sampling a signal which has passed through a low pass filter, a band pass filter part for further filtering the signal only through particular frequency band and a calculation part for calculating a moving speed of a movable body from a sonic speed, the particular frequency and frequency of the signal which has passed through the band pass filter part, thereby mismeasurement may be prevented.

It is yet a furthermore object of the present invention to provide the mentioned display part comprising a display driving part connected to the mentioned calculation part to generate a display driving signal and a display board part receiving a display driving signal to display an image, thereby a speed may easily be measured.

It is a still furthermore object of the present invention to provide the mentioned movable body wherein a radio control reception control part radio-controlling a movable body by receiving a radio control signal is connected to the mentioned ultrasonic wave sensor drive circuit, thereby the system of the present invention may be radio controlled.

It is yet a furthermore object of the present invention to provide the mentioned radio control reception control part connected to an aerial wire receiving a radio control signal through a reception part demodulating a radio control signal and also connected to a driving part moving a movable body, thereby a control for generation of ultrasonic wave in the system of the present invention may be possible.

It is a still furthermore object of the present invention to provide the mentioned calculation part further connected to a radio control transmission control part transmitting a radio control signal for controlling a movable body, thereby a result of the calculation is transmitted to a radio control reception control part.

It is yet a furthermore object of the present invention to provide the mentioned radio control transmission control part further connected to a input part for operating a movable body to a random state, a storage part for storing the information received from a calculation part and a transmission part for generating a control signal, and the mentioned transmission part connected to an aerial wire, thereby a measured content in the system of the present invention may be feedback to a movable body.

It is yet a furthermore object of the present invention to provide the mentioned ultrasonic wave sensor output part having directivity in more than one particular directions, thereby a measurement with a high precision may be possible without depending to directivity.

It is yet a furthermore object of the present invention to provide the mentioned ultrasonic wave sensor output part not having directivity, thereby a measurement with a high precision may be possible without depending to directivity.

It is yet a furthermore object of the present invention to provide a ultrasonic wave sensor output part mounted on a movable body generating and outputting an ultrasonic wave signal of a particular frequency, so that the outputted ultrasonic wave signal is received by an ultrasonic wave signal reception part, a determination part determines difference between the frequency of the mentioned ultrasonic wave signal received by the mentioned ultrasonic wave signal reception part and the mentioned particular frequency, a calculation part calculates a speed of the mentioned movable body from a signal of the determined difference and the display part displays the calculated result, thereby a measurement with a high precision may be possible.

It is yet a furthermore object of the present invention to provide a radio controlled movable toy wherein an ultrasonic wave signal output part is mounted on a radio controlled movable body, and an ultrasonic wave signal reception part, a determination part, a calculation part and a display part are mounted on a transmitter for radio control, thereby a measurement of a speed of a radio controlled movable toy with a high precision may be possible.

### Means for Solving the Issue

The first aspect of the present invention is to provide a movable body speed measuring system comprising a movable body on which an ultrasonic wave signal output part for producing and outputting an ultrasonic wave signal of a particular frequency is mounted; an ultrasonic wave signal reception part for receiving the outputted ultrasonic wave signal; a determination part-for determining the difference between the frequency of the ultrasonic wave signal received by the ultrasonic wave signal reception part and the particular frequency; a calculation part for calculating the speed of the movable body from a signal of the determination difference; and a display part for displaying a result of the calculation.

Further, the mentioned ultrasonic wave signal output part provides an oscillator circuit for transmission to oscillate a signal of the particular frequency, a booster circuit for signal amplification to boost voltage,. an ultrasonic wave sensor drive circuit for driving ultrasonic wave sensor by an oscillation signal and the boosted voltage and an ultrasonic transducer.

Still further, a plurality of the mentioned oscillator circuits for transmission is configured so that any one of the oscillator circuits is selected by selecting means to be connected to the mentioned ultrasonic wave sensor drive circuit.

Yet further, the mentioned ultrasonic wave signal reception part provides an ultrasonic wave sensor input part including a receiver comprising an ultrasonic transducer and so on and an amplification part for amplifying a signal from a receiver.

Furthermore, the mentioned determination part provides an oscillator circuit part for reception to oscillate a signal of the particular frequency, a frequency difference extraction circuit part mixing a signal of the mentioned particular frequency and a signal amplified at the mentioned amplification part, and a low-pass filter part selectively making a signal of the frequency difference passes through.

Still furthermore, a plurality of the mentioned oscillator circuits for reception is configured so that any one of the oscillator circuits for reception may, by selective means, be connected to the mentioned frequency difference extraction circuit part.

Yet furthermore, the mentioned calculation part provides a sampling part for sampling a signal which has passed through a low pass filter, a band pass filter part for further filtering the signal only through particular frequency band and a calculation part for calculating a moving speed of a movable body from a sonic speed, the particular frequency and frequency of the signal which has passed through the band pass filter part.

Still furthermore, the mentioned display part provides a display driving part connected to the mentioned calculation part to generate a display driving signal and a display board part receiving a display driving signal to display an image.

Yet furthermore, the mentioned movable body is characterized in that a radio control reception control part radio-controlling a movable body by receiving a radio control signal is connected to the mentioned ultrasonic wave sensor drive circuit.

Still furthermore, the mentioned radio control reception control part is connected to an aerial wire receiving a radio control signal through a reception part demodulating a radio control signal and also connected to a driving part moving a movable body.

Yet furthermore, the mentioned calculation part is further connected to a radio control transmission control part transmitting a radio control signal for controlling a movable body.

Still furthermore, the mentioned radio control transmission control part is further connected to a reception part for operating a movable body to a random state, a storage part for storing the information received from a calculation part and a transmission part for generating a control signal, and the mentioned transmission part connected to an aerial wire.

Yet furthermore, the mentioned ultrasonic wave sensor output part has directivity in more than one particular directions. Also, the mentioned ultrasonic wave sensor output part does not have directivity in particular direction.

The second aspect of the present invention is a movable body speed measuring system wherein an ultrasonic wave sensor output part mounted on a movable body generates and outputs an ultrasonic wave signal of a particular frequency, so that the outputted ultrasonic wave signal is received by an ultrasonic wave signal reception part, a determination part determines difference between the frequency of the mentioned ultrasonic wave signal received by the mentioned ultrasonic wave signal reception part and the mentioned particular frequency, a calculation part calculates a speed of the mentioned movable body from a signal of the determined difference and the display part displays the calculated result.

The third aspect of the present invention is a radio controlled movable toy wherein an ultrasonic wave signal output part is mounted on a radio controlled movable body, and an ultrasonic wave signal reception part, a determination part, a calculation part and a display part are mounted on a transmitter for radio control.

### Effects of the Invention

It is an effect of the present invention to, as mentioned, provide a movable body on which an ultrasonic wave signal output-part for producing and outputting an ultrasonic wave signal of a particular frequency is mounted; an ultrasonic wave signal reception part for receiving the outputted ultrasonic wave signal; a determination part for determining the difference between the frequency of the ultrasonic wave signal received by the ultrasonic wave signal reception part and the particular frequency; a calculation part for calculating the speed of the movable body from a signal of the determination difference; and a display part for displaying a result of the calculation, thereby a speed of a movable body moving at low speed may be measured with a high precision.

It is a further effect of the present invention to provide a speed measurement utilizing an ultrasonic wave Doppler claimed in the present invention wherein a transmission of ultrasonic wave and a reception of ultrasonic wave are separate structure, thereby a whole system becomes compact and an error factor, namely precision of length measurement and a precision of running position are not required, for which reason measurement is performed with high precision. Further, the compact configuration enables low price of manpower for manufacturing and materials.

It is a still further effect of the present invention to provide a simple measurement of directing a receptor to a transmitter, thereby length measurement and position setting are not required, for which reason measurement is performed with high precision.

It is yet a further effect of the present invention to provide a determination by direct wave, thereby a transmitter becomes low output, a circuit becomes simple and manpower for manufacturing and material become low price.

It is a furthermore effect of the present invention to provide ultrasonic wave not reflecting against a movable body and a signal outputting from a measured target, thereby a surface shape and size of the measured target have no effect, for which reason measurement is performed with high precision.

It is a still furthermore effect of the present invention to provide an ultrasonic wave signal output part for producing and outputting an ultrasonic wave signal of a particular frequency, thereby low speed less than 1 km/h may be easily measured.

It is yet a furthermore effect of the present invention to provide the mentioned ultrasonic wave signal output part mounted on a movable body, thereby a direct wave is utilized to reduce a load of the output part.

It is a still furthermore effect of the present invention to provide an ultrasonic wave signal reception part for receiving the outputted ultrasonic wave signal, thereby a speed may be measured at a close distance.

It is yet a furthermore effect of the present invention to provide a determination part for determining the difference between the frequency of the mentioned ultrasonic wave signal received by the mentioned ultrasonic wave signal reception part and the mentioned particular frequency, thereby a speed may be measured with a high precision.

It is a still furthermore effect of the present invention to provide a calculation part for calculating the speed of the movable body from a signal of the determination difference, thereby a correct speed may be calculated.

It is yet a furthermore effect of the present invention to provide a display part for displaying a result of the calculation, thereby a speed may easily be notified.

It is a still furthermore effect of the present invention to provide the mentioned ultrasonic wave signal output part comprising an oscillator circuit for transmission to oscillate a signal of the particular frequency, a booster circuit for signal amplification to boost voltage, an ultrasonic wave sensor drive circuit for driving ultrasonic wave sensor by an oscillation signal and the boosted voltage and an ultrasonic transducer, thereby ultrasonic wave having sufficiently large amplification may be generated by a low voltage battery.

It is yet a furthermore effect of the present invention to provide a plurality of the mentioned oscillator circuits for transmission configured so that any one of the oscillator circuits for transmission may, by selecting means, be selected to be connected to the mentioned ultrasonic wave sensor drive circuit, thereby it is possible to concurrently measure speeds of a plurality of movable bodies moving all together in close proximity.

It is a still furthermore effect of the present invention to provide the mentioned ultrasonic wave signal reception part comprising an ultrasonic wave sensor input part including a receiver comprising an ultrasonic transducer and so on and an amplification part for amplifying a signal from a receiver, thereby a minute ultrasonic wave signal may easily be determined.

It is yet a furthermore effect of the present invention to provide the mentioned determination part comprising an oscillator circuit part for reception to oscillate a signal of the particular frequency, a frequency difference extraction circuit part mixing a signal of the mentioned particular frequency and a signal amplified at the mentioned amplification part, and a low-pass filter part selectively making a signal of the frequency difference pass through, thereby only the necessary signal of the difference is extracted.

It is still a furthermore effect of the present invention to provide a plurality of the mentioned oscillator circuits for reception configured so that any one of the oscillator circuits for reception may, by selective means, be connected to the mentioned frequency difference extraction circuit part for enabling correspondence to the change of transmit frequency.

It is yet a furthermore effect of the present invention to provide the mentioned calculation part comprising a sampling part for sampling a signal which has passed through a low pass filter, a band pass filter part for further filtering the signal only through particular frequency band and a calculation part for calculating a moving speed of a movable body from a sonic speed, the particular frequency and frequency of the signal which has passed through the band pass filter part, thereby mismeasurement may be prevented.

It is a still furthermore effect of the present invention to provide the mentioned display part comprising a display driving part connected to the mentioned calculation part to generate a display driving signal and a display board part receiving a display driving signal to display an image, thereby a speed may easily be measured.

It is yet a furthermore effect of the present invention to provide the mentioned movable body wherein a radio control reception control part radio-controlling a movable body by receiving a radio control signal is connected to the mentioned ultrasonic wave sensor drive circuit, thereby the system of the present invention may be radio controlled.

It is a still furthermore effect of the present invention to provide the mentioned radio control reception part connected to an aerial wire receiving a radio control signal through a reception part demodulating a radio control signal and also connected to a driving part moving a movable body, thereby a control for generation of ultrasonic wave in the system of the present invention may be possible.

It is yet a furthermore effect of the present invention to provide the mentioned calculation part further connected to a radio control transmission control part transmitting a radio control signal for controlling a movable body, thereby a result of the calculation is transmitted to a radio control reception control part.

It is a still furthermore effect of the present invention to provide the mentioned radio control transmission control part further connected to a reception part for operating a movable body to a random state, a storage part for storing the information received from a calculation part and a transmission part for generating a control signal, and the mentioned transmission part connected to an aerial wire, thereby a measured content in the system of the present invention may be feedback to a movable body.

It is yet a furthermore effect of the present invention to provide the mentioned ultrasonic wave sensor output part having directivity in more than one particular directions, thereby a measurement with a high precision may be possible without depending to directivity.

It is a still furthermore effect of the present invention to provide the mentioned ultrasonic wave sensor output part not having directivity, thereby a measurement with a high precision may be possible without depending to directivity.

It is yet a furthermore effect of the present invention to provide a ultrasonic wave sensor output part mounted on a movable body generating and outputting an ultrasonic wave signal of a particular frequency, so that the outputted ultrasonic wave signal is received by an ultrasonic wave signal reception part, a determination part determines difference between the frequency of the mentioned ultrasonic wave signal received by the mentioned ultrasonic wave signal reception part and the mentioned particular frequency, a calculation part calculates a speed of the mentioned movable body from the signal of the determined difference and the display part displays the calculated result, thereby a measurement with a high precision may be possible.

It is a still furthermore effect of the present invention to provide a radio controlled movable toy wherein an ultrasonic wave signal output part is mounted on a radio controlled movable body, and an ultrasonic wave signal reception part, a determination part, a calculation part and a display part are mounted on a transmitter for radio control, thereby a measurement of a speed of a radio controlled movable toy with a high precision may be possible.

### THE BEST MODE FOR CARRYING OUT THE INVENTION

The present invention is explained based on the embodiments shown in the figures as follows.

### The First Embodiment

The conceptual diagrams of the movable body speed measuring system described in the present invention are shown in FIGS. 1A, 1B and 1C. FIG. 1A shows a side view of the movable body of the movable body speed measuring system described in the present invention. Ultrasonic Wave Signal Output Part 4 of the movable body speed measuring system described in the present invention is mounted at the roof part of a movable body or Car Toy 2 so that ultrasonic wave is emitted toward the front direction.

On the other hand, FIG. 1B shows a side view of Reception Part 6 of the movable body speed measuring system described in the present invention. Reception Part 6 provides Main Body 8 for receiving the ultrasonic wave and calculating the speed and Trigger 12 for starting reception provided near the connection part of Gripping Part 10 jutting out from Main Body 8.

FIG. 1C shows a front view of Operation Panel 14 of the movable body speed measuring system described in the present invention. In front of Main Body 8, an ultrasonic wave signal reception part is provided. On the other hand, in back of the Main Body 8, Operation Panel 14 is provided. Operation Panel 14 provides Speed Display Panel 16 for displaying the measured speed and Speed Unit Changeover Switch 18 for switching speed unit.

FIG. 1D shows a block diagram of Ultrasonic Wave Signal Output Part 4, and

FIG. 1E shows a block diagram of Reception Part 6.

The movable body speed measuring system described in the present invention comprises Movable Body 2, Ultrasonic Wave Signal Output Part 4, Ultrasonic Wave Signal Reception Part 20, Determination Part 22, Calculation Part 24 and Display Part 26. Movable Body 2 mounts Ultrasonic Wave Signal Output Part 4 which is configured to generate and output an ultrasonic wave signal of 38 KHz. Ultrasonic Wave Signal Reception Part 20 is configured to receive the outputted ultrasonic wave signal. Determination Part 22 determines the difference between the frequency of the ultrasonic wave signal received by the ultrasonic wave signal reception part and the particular frequency. Calculation Part 24 is configured to calculate the speed of the movable body from a signal of the determination difference. Display Part 26 is configured to display a result of the calculation.

Ultrasonic Wave Signal Output Part 4 includes Oscillator Circuit 28 for transmission to oscillate a signal of the particular frequency or 38 kHz here, Booster Circuit 30 for signal amplification to boost voltage, Ultrasonic Wave Sensor Drive Circuit 32 for driving ultrasonic wave sensor by an oscillation signal and the boosted voltage and Ultrasonic Transducer 34. Power Supply 33 of 6V is connected to Oscillator Circuit 28 for transmission and Booster Circuit 30.

Oscillator Circuit 28 for transmission preferably is a circuit providing a crystal oscillator. Booster Circuit 30 may be any one of a booster circuit comprising a booster coil, a circuit comprising a switching regulator or a circuit comprising a DC-DC converter.

Ultrasonic Wave Sensor Drive Circuit 32 is, for example, connecting inverter elements of two logic circuits in parallel and connected to each electrode of Ultrasonic Transducer 34 for driving. One of the electrodes of Ultrasonic Transducer 34 is connected to Ultrasonic Wave Sensor Drive Circuit 32 through Capacitor 36. The connection through Capacitor 36 cuts DC component, thereby voltage twice as much as the driving voltage is applied to Ultrasonic. Transducer 34.

Ultrasonic Transducer 34 is an ultrasonic transducer for transmission comprising BaTiO₃, PZT (piezoelectric element), PbTiO₃ and so on, which may be either one of drip-proof type or open type, and are driven by Ultrasonic Wave Sensor Drive Circuit 32 to transmit ultrasonic wave of 38 kHz. Ultrasonic Transducer 34, which has directivity, is arranged facing to the direction of movement of a movable body.

Reception Part 6, as shown in FIG. 1E, comprises Ultrasonic Wave Signal Reception Part 20, Determination Part 22, Calculation Part 24 and Display Part 26.

Ultrasonic Wave Signal Reception Part 20 comprises Ultrasonic Wave Sensor Reception Part 40 including Receiver 38 comprising an ultrasonic transducer and so on and Amplification Part 42 amplifying a signal from Receiver 38.

Receiver 38, comprising an ultrasonic transducer and so on, is an ultrasonic transducer for reception comprising BaTiO₃, PZT (piezoelectric element), PbTiO₃ and so on, which may be either one of drip-proof type or open type, and is configured to receive ultrasonic wave signal and convert it into sonic wave.

Amplification Part 42 provides a function to amplify a signal from Receiver 38 and output it as a received signal and comprises, for example, an amplifier circuit including an operational amplifier.

Determination Part 22 provides Oscillator Circuit Part For Reception 44 oscillating a signal of the particular frequency or 38 kHz as a basic oscillation, Frequency Difference Extraction Circuit Part 46 mixing a signal of 38 kHz and the signal amplified at Amplification Part 42 and Low-Pass Filter Part 48 selectively making a signal of the frequency difference pass through.

Oscillator Circuit Part For Reception 44 preferably is a circuit providing a crystal oscillator. Booster Circuit 30 may be any one of a booster circuit boosting voltage in proportion to the winding number of a transformer, a circuit comprising a switching regulator or a circuit comprising a DC-DC converter. However, frequency of an oscillator circuit particularly relates to accuracy of the present invention, for which reason it preferably is a circuit stably oscillating in the same frequency, and more preferably is a circuit using a crystal oscillator.

Frequency Difference Extraction Circuit Part 46 is a circuit for generating a signal of the difference generated by the principle of sum and difference of wave by combining an ultrasonic wave signal outputted from Ultrasonic Wave Signal Output Part 4 mounted on Car Toy 2 with a basic signal generated by Oscillator Circuit Part For Reception 44. An ultrasonic wave signal outputted from Ultrasonic Wave Signal Output Part 4 mounted on Car Toy 2 is originally identical with basic frequency. However, a movement of Car Toy 2 generates Doppler effect which causes a shift of frequency, for which reason a difference between the original frequency is generated.

Low Pass Filter Part 48 is configured to attenuate a signal of sum or high frequency element in order to extract an element of the difference required for obtaining a speed from signals of the difference including element of sum and difference generated at Frequency Difference Extraction Circuit .Part 46. It comprises a circuit including an operational amplifier and a passive circuit, a switched capacitor filter or a digital filter including DSP.

Calculation Part 24 provides Sampling Part 50 for sampling a signal which has passed through Low Pass Filter 48, Band Pass Filter Part 52 for further filtering the signal only through particular frequency band and Calculation Part 54 for calculating a moving speed of a movable body from a sonic speed, the particular frequency and frequency of the signal which has passed through Band Pass Filter Part 52, all of which are not shown in the figures. The cut off frequency of Low Pass Filter 48 is (41 kHz).

Sampling Part 50 is an AD conversion circuit, which is configured to digitize the analog signal which has passed through Low Pass Filter Part 48 by the sampling rate of 2 MHz and to sequentially store the frequency values of each sampling time in Memory 56.

Band Pass Filter Part 52 is configured to remove the noise in the unnecessary band including folding noise by the filtering procedure of the signal stored in Memory 56 using a software. The circuit configuration is comprises an FIR filter or an IIR filter. The passing frequency of Band Pass Filter Part 52 is (from 34 kHz to 41 kHz).

Calculation Part 54 is configured to calculate the speed v of a movable body from the sonic speed vo, the basic frequency fo by Oscillator Circuit Part For Reception 44 and Δf received by Reception Part 6. Namely, it comprises Memory. 56 previously storing the sonic speed vo and the basic frequency fo as data and an arithmetic element wherein Calculation Part 54 retrieves the data of the sonic speed vo, the basic frequency fo and the frequency values of each sampling time from Memory 56 (storing the data), enters the data into the predetermined formula and calculate using the stored data. The calculated moving data of a movable body is configured to be stored again in the other address of Memory 56. It may also be configured so that speed data is decided according to each sample. However, it preferably is configured so that speed data is decided according to the average value in a given time or a value is adopted only in the case that the speed of no less than specific number of times and within a given range is consecutively calculated. Additionally, it may also be configured to display error in the case that the value out of the predetermined range is calculated. Further, it may also be configured to display error in the case that Receiver 38 dose not receive ultrasonic wave.

Further, Calculation Part 24 is connected to Liquid Crystal Driver 58 which is connected to Liquid Crystal Display 60.

Liquid Crystal Driver 58 is an LSI driving Liquid Crystal Display 60 which, in case of TFT type liquid crystal, comprises a gate driver and a source driver.

Liquid Crystal Display 60 is a device for receiving and displaying a speed data in Memory 56 stored from Calculation Part 24, which is configured to be driven by Liquid Crystal Driver 58.

Calculation Part 24 is further connected to Speed Measurement Switch 12, Speed Unit Changeover Switch 18, Power Supply Circuit 62, Buttery 64, Power Supply Switch 66, Voltage Reduction Detecting Circuit 68, Reset Circuit 70 and 8 MHz Crystal 72.

Speed Measurement Switch 12 is a trigger for starting a reception located near the connection part of Gripping Part 10 sidlingly jutting out from Main Body 8 receiving the mentioned ultrasonic wave and calculating a speed, which is provided between Sampling Part 50 and a power supply and is configured to control start and stop of Sampling Part 50.

Speed Unit Changeover Switch 18 is a switch for switching 0.1 km/h and 0.1 mile/h. Namely, it is configured to normally display a speed by km/h, and when the switch is switched, the speed is multiplied by 0.621371 and the result is shown.

Power Supply Circuit 62 is connected to Calculation Part 24 by two kinds of conductive wires. The first Conductive Wire 74 is an auto power off control signal line, which, in the case that either signal or operation is inputted from Calculation Part 24 and a given length of time has passed, transmits a signal to power off.

The second Conductive Wire 76 is a power supply driving line. On the other hand, Power Supply Circuit 62 is further connected to Battery 64, Power Supply On/Off Switch 66 and Voltage Reduction Detecting Circuit 68 respectively.

Battery 64 is a power supply for operation of a circuit including Calculation Part 24, voltage of which preferably is 6V. Power Supply On/Off Switch 66 is a power supply switch of Reception Part 6. Power Supply On/Off Switch 66 is one of the triggers having timer function for power supply operation time of an auto power off circuit at Calculation Part 24. Power Supply On/Off Switch 66 is provided between Power Supply Circuit 62 and Battery 64. Auto power off preferably is configured so that the power is cut off in the case that the state of non-operation and non-signal continues for consecutive fifteen minutes.

Voltage Reduction Detecting Circuit 68 is also connected to Calculation Part 24, which periodically measures voltage of Battery 64 and, in the case that output voltage of Battery 64 is specific voltage or less, records the effect together with the voltage value in Calculation Part 24. On the other hand, in the case that voltage reduces further lower, auto power off signal is generated, and thereby Power Supply Circuit 62 and a power supply are cut off.

Reset Circuit 70 is a switch for sending a reset signal to Calculation Part 24. Calculation Part 24 is configured, in the case of receiving a reset signal, to change all the configurations to the default values. 8 MHz Crystal 72 is a crystal oscillator for driving Calculation Part 24.

According to the mentioned configuration, the method of movable body speed measuring described in the present invention is explained by using FIG. 5.

At first, a power supply of the switch provided in Transmitter 4 mounted in Car Toy 2, which is not shown in the figures, is turned ON. In Transmitter 4, Battery 64 is boosted by Booster Circuit 30. Ultrasonic Wave Sensor Drive Circuit 32 amplifies the signal oscillated from 38 kHz Oscillator Circuit 28 by the boosted voltage, and drives Ultrasonic Transducer 34 by the amplified signal and output the same as ultrasonic wave (A2).

Next, Trigger 12 provided in Reception Part 6 is turned ON, thereby Reception Part 6 starts operating (A4).

Receiver 38 of Reception Part 6 is arranged toward the running Car Toy 2, and Receiver 38 receives the ultrasonic wave oscillated from Ultrasonic Wave Signal Output Part 4 mounted in Car Toy 2 and converts the same into electronic signal (A6).

Amplification Part 42 amplifies the signal received by Receiver 38 (A8). Frequency Difference Extraction Circuit Part 46 mixes the received signal of the frequency fi outputted from Amplification Part 42 and the oscillation signal of the mentioned frequency fo (38 kHz) generated from Oscillator Circuit Part For Reception 44 (A10). The signal of the frequency (fi+fo) and the signal of the frequency (fi−fo) are generated respectively.

The mixed signal or the signal of the frequency (fi+fo) and the frequency (fd=fi−fo) goes to Low Pass Filter Part 48 (A12). The frequency of the signal passing through Low Pass Filter Part 48 is almost only the frequency (fd=fi−fo).

Subsequently, AD converter or Sampling Part 50 in the Calculation Part 24 digitizes the signal which has passed through Low Pass Filter Part 48 at the clock of 2 MHz into (10 bit) and converts the same into a binary value (A 14).

Further, the noises and the like of the binarized signal are removed at FIR filter or Band Pass Filter 52 (A 16).

The frequency of a signal fd=fi−fo is calculated from the signal which has passed through Band Pass Filter Part 52 (A18). Then, it is determined whether or not fd value of consecutive equivalence may be measured particular number of times. In the case that it is impossible to consecutively determine it, it is decided as incapable measurement.

The speed v of the movable body is calculated from the measured fd and the sonic speed vp as follows (A20):

### [Formula 1]

v=fd·vp/(fo+fd) (1)

The calculated speed is displayed in Liquid Crystal Display 60 through Liquid Crystal Driver 58 (A22). In case of incapable measurement, “error” is displayed in Liquid Crystal Display 60.

### The Second Embodiment

The conceptual diagrams of the movable body speed measuring system described in of the second embodiment of the present invention are shown in FIGS. 2A and 2B. FIG. 2A shows a block diagram of Ultrasonic Wave Signal Output Part 4 and FIG. 2B shows a block diagram of Reception Part 6.

Only the different aspects between the first embodiment of the present invention are shown. The movable body speed measuring system described in the second embodiment of the present invention provides plurality of Oscillator Circuits 28 and 27 between Battery 33 and Ultrasonic Wave Sensor Drive Circuit 32 at Ultrasonic Wave Signal Output Part 4. The interlocking Changeover Switches 29 and 31 are provided among these plurality of Oscillator Circuits 28 and 27, Battery 33 and Ultrasonic Wave Sensor Drive Circuit 32.

Likewise, plurality of Oscillator Circuits 44 and 45 are provided at Frequency Difference Extraction Circuit Part 46 in Reception Part 6, and Changeover Switch 49 is provided between them.

Switch 49 changes according to the changeover of Changeover Switches 29 and 31. Changeover Switches 29, 31 and 49 comprise any one of a manual switch, a relay switch, an electronic switch or just a changeover switch for replacing crystal oscillator and others.

The selected frequencies of an oscillator circuit should have more than a given difference of frequencies each other. Namely, in the case that the difference of frequencies is no more than a multiple number of the shift of frequency caused by Doppler effect, measurement is affected.

As mentioned, plurality of oscillating frequencies may be selected, thereby, in the case that plurality of the movable body speed measuring systems are used at the same time, it is also possible to measure the adjacent car at the same time.

### The Third Embodiment

The conceptual diagrams of the movable body speed measuring system described in of the third embodiment of the present invention are shown in FIGS. 3A and 3B. FIG. 3A shows a block diagram of Ultrasonic Wave Signal Output Part 4 and FIG. 3B shows a block diagram of Reception Part 6.

Only the different aspects between the first embodiment of the present invention are shown. The movable body speed measuring system described in the third embodiment of the present invention comprises a combined configuration of the movable body speed measuring system and Car Toy 2.

As shown in FIG. 3A, Ultrasonic Wave Sensor Drive Circuit 32 of the movable body speed measuring system is connected to a radio-controlled car or Control Part 78 for controlling a radio controller. Control Part 78 is connected to Reception Part 80 for receiving a control signal of a radio controller. Reception Part 80 is connected to Antenna 82 for receiving the electromagnetic wave modulated by the control signal. On the other hand, Control Part 78 is further connected to Driving Part 84 for rotating the wheels of a radio controlled car.

Reception Part 80 comprises a high frequency amplification part for amplifying a signal from a transmitter, an intermediate frequency amplification part for converting the signal into an intermediate frequency signal and amplifying the same and a control signal part for separating an intermediate signal from the intermediate frequency amplification part.

Control Part 78 receives a control signal of Reception Part 80 and separates the signal into a driving signal and a steering signal and transmits the same to Driving Part 84.

Driving Part 84, in case of an electric car, controls a motor by a driving signal and controls a handling of a radio control car by a steering signal. Further functions may be added to a control part to transmit a signal to stop driving to Ultrasonic Wave Sensor Drive Circuit 32.

Further, in case of a configuration wherein an oscillation circuit is selectable as in the case of the second embodiment, the configuration comprises a transmitter for transmitting a frequency selecting signal and operating a select switch by a selecting signal received by Control Part 78 through Ultrasonic Wave Sensor Drive Circuit 32.

On the other hand, as shown in FIG. 3B, Calculation Part 24 of Reception Part 6 is connected to Control Part 86 for controlling Car Toy 2. Control Part 86 is connected to Antenna 88 through Transmitting Part 87, and further connected to Stick 90 for controlling and Memory 92 for storing information received from a calculation part respectively.

Control Part 86 is configured so that AD converter which is not shown in the figures converts operational information input from Stick 90 or change information of resistance value of a register arranged at Stick 90 into a digital signal, further converts the digital signal into channel data-which is digital data or signal for controlling a radio controlled toy and transmit the channel data to Transmitting Part 87, and so that a speed signal is received from Calculation Part 24 and if the speed is slower than the predetermined speed, an acceleration signal is generated and if the speed is faster than the predetermined speed, a deceleration signal is generated wherein each signal is converted into a channel data and transmitted to Transmitting Part 87.

Transmitting Part 87 is configured to transmit a high frequency wave signal modulated by the channel data generated at Control Part 86 from Antenna 88.

Stick 90 is jointed to a volume arranged corresponding to some channel so that the output voltage values change in conjunction each other, which is a means to obtain the information corresponding to the operating angle of a stick and is a device generally used for a transmitter of radio control.

The mentioned configuration is enabled to feedback speed information received by Ultrasonic Wave Sensor Drive Circuit 32 to a car toy.

In addition, speed information may be comparison with a given speed. It is also possible to program so that a speed may comply with a predetermined hourly schedule stored in a memory and the like.

### The Fourth Embodiment

The conceptual diagrams of the movable body speed measuring system described in the forth embodiment of the present invention are shown in FIG. 4. FIG. 4 shows a side view of the movable body of the movable body speed measuring system described in the present invention. Plurality of Ultrasonic Wave Signal Output Part 4 is mounted. In FIG. 4, Ultrasonic Wave Signal Output Part 4 comprises Ultrasonic Wave Signal Output Part For Front Use 4a and Ultrasonic Wave Signal Output Part For Rear Use 4b attached facing each other.

For example, directivity may be provided in all direction of a car to enable easier measurement from front and back.

### INDUSTRIAL APPLICABILITY

The present invention enables an easy measurement of an object moving at low speed, for example, a toy, a person, a pet and the like, which may be used for a toy. Further, it may also be utilized for educational materials and health appliances such as a simple experiment and a speed measurement during walking.

While the invention has been described with reference to certain preferable embodiments, it will be understood that the embodiments are described only for the purpose of exemplifying explanation and do not mean any limitation. It is clear that, after reading the present specification, various changes and modifications may be made by using equivalent components and arts by the person skilled in the art. However, it is clear that these changes and modifications should fall within true scope and spirit of the appended claims.

### BRIEF DESCRIPTION OF DRAWINGS

FIG. 1A shows a side view of the movable body of the movable body speed measuring system described in the present invention.

FIG. 1B shows a side view of the reception part in the movable body speed measuring system of the first embodiment described in the present invention.

FIG. 1C shows a front view of the operation panel in the movable body speed measuring system of the first embodiment described in the present invention.

FIG. 1D shows a block diagram of Ultrasonic Wave Signal Output Part 4 in the movable body speed measuring system of the first embodiment described in the present invention.

FIG. 1E shows a block diagram of Reception Part 6 in the movable body speed measuring system of the first embodiment described in the present invention.

FIG. 2A shows a block diagram of Ultrasonic Wave Signal Output Part 4 in the movable body speed measuring system of the second embodiment described in the present invention.

FIG. 2B shows a block diagram of Reception Part 6 in the movable body speed measuring system of the second embodiment described in the present invention.

FIG. 3A shows a block diagram of Ultrasonic Wave Signal Output Part 4 in the movable body speed measuring system of the third embodiment described in the present invention.

FIG. 3B shows a block diagram of Reception Part 6 in the movable body speed measuring system of the third embodiment described in the present invention.

FIG. 4 shows a side view of the movable body in the movable body speed measuring system of the fourth embodiment described in the present invention

FIG. 5 shows a flowchart of the movable body speed measuring system of the first embodiment described in the present invention.

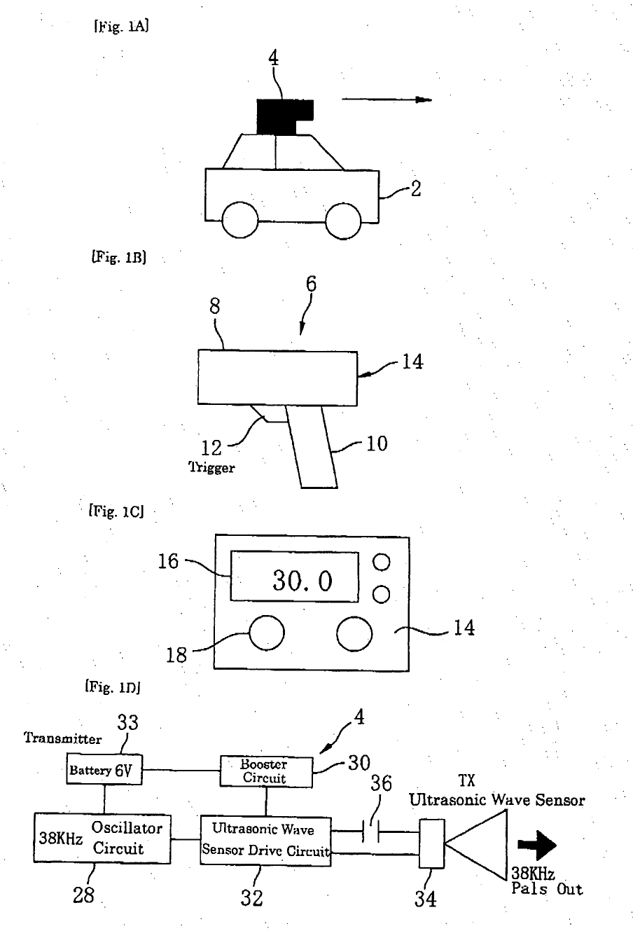

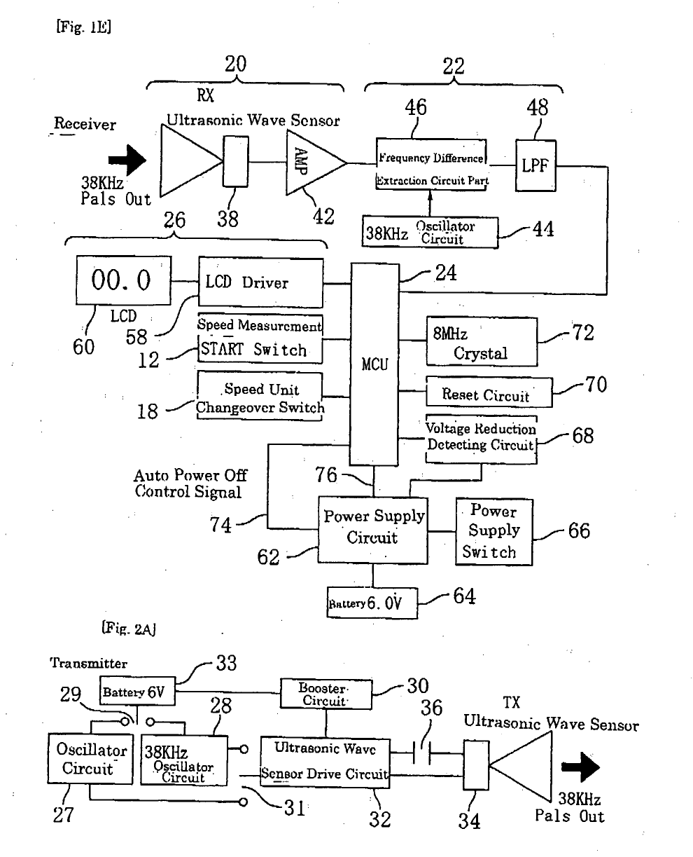

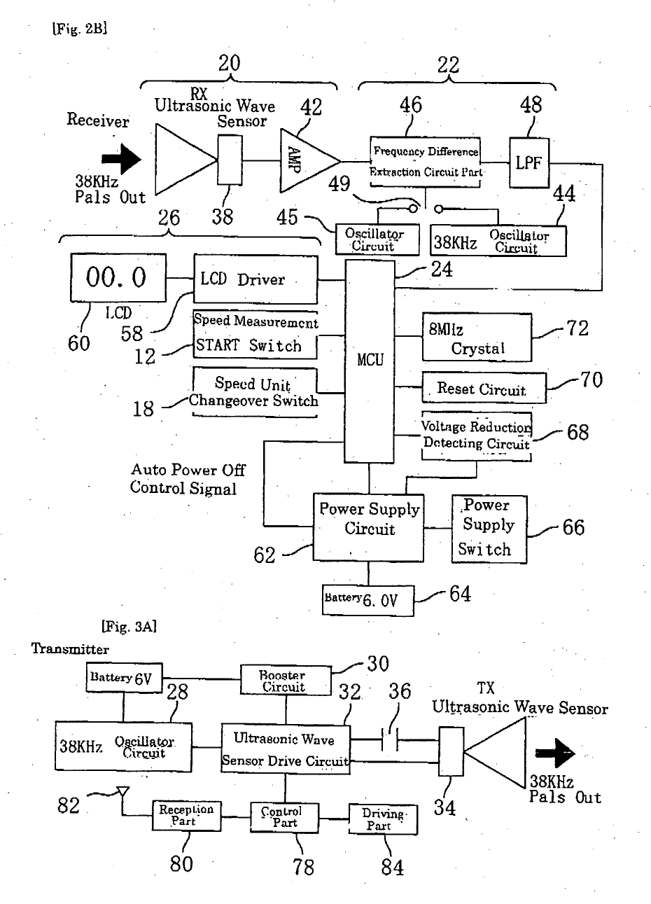

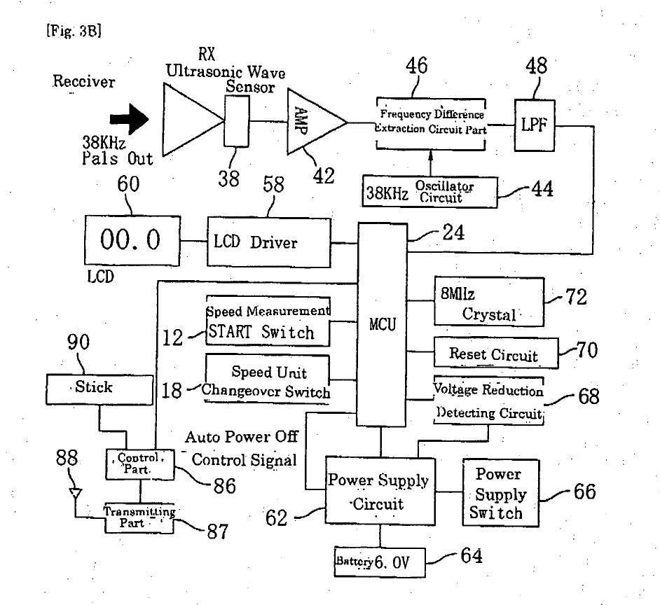

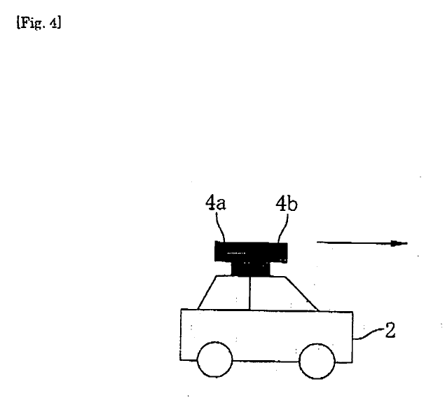

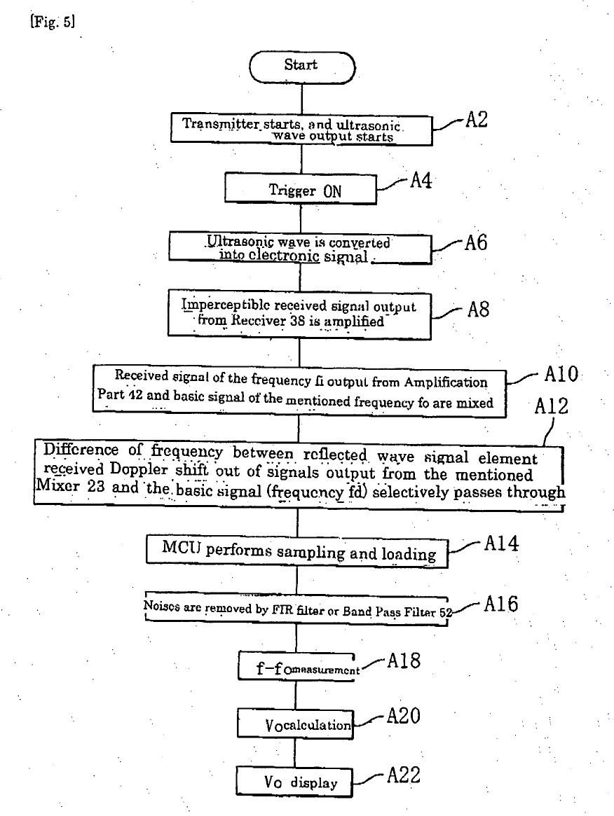

1. A movable body speed measuring system comprising:
a movable body on which an ultrasonic wave signal output part for producing and outputting an ultrasonic wave signal of a particular frequency is mounted;
an ultrasonic wave signal reception part for receiving the outputted ultrasonic wave signal;
a determination part for determining the difference between the frequency of the ultrasonic wave signal received by the ultrasonic wave signal reception part and the particular frequency;
a calculation part for calculating the speed of the movable body from a signal of the determination difference; and
a display part for displaying a result of the calculation.

2. A movable body speed measuring system as claimed in claim 1, wherein the mentioned ultrasonic wave signal output part comprises an oscillator circuit for transmission to oscillate a signal of the particular frequency, a booster circuit for signal amplification to boost voltage, an ultrasonic wave sensor drive circuit for driving ultrasonic wave sensor by an oscillation signal and the boosted voltage and an ultrasonic transducer.

3. A movable body speed measuring system as claimed in claim 2, wherein a plurality of the mentioned oscillator circuits for transmission is provided and configured so that any one of the oscillator circuits for transmission may, by selecting means, be selected to be connected to the mentioned ultrasonic wave sensor drive circuit.

4. A movable body speed measuring system as claimed in claim 1, wherein the mentioned ultrasonic wave signal reception part comprises an ultrasonic wave sensor input part including a receiver comprising an ultrasonic transducer and so on and an amplification part for amplifying a signal from a receiver.

5. A movable body speed measuring system as claimed in claim 4, wherein the mentioned determination part comprises an oscillator circuit part for reception to oscillate a signal of the particular frequency, a frequency difference extraction circuit part mixing a signal of the mentioned particular frequency and a signal amplified at the mentioned amplification part, and a low-pass filter part selectively making a signal of the frequency difference pass through.

6. A movable body speed measuring system as claimed in claim 5, wherein a plurality of the mentioned oscillator circuits for reception is provided and configured so that any one of the oscillator circuits for reception may, by selective means, be connected to the mentioned frequency difference extraction circuit part for enabling correspondence to the change of transmit frequency.

7. A movable body speed measuring system as claimed in claim 5, wherein the mentioned calculation part comprises a sampling part for sampling a signal which has passed through a low pass filter, a band pass filter part for further filtering the signal only through particular frequency band and a calculation part for calculating a moving speed of a movable body from a sonic speed, the particular frequency and frequency of the signal which has passed through the band pass filter part.

8. A movable body speed measuring system as claimed in claim 5, wherein the mentioned display part comprises a display driving part connected to the mentioned calculation part to generate a display driving signal and a display board part receiving a display driving signal to display an image.

9. A movable body speed measuring system as claimed in claim 2, wherein the mentioned movable body comprises a radio control reception control part radio-controlling a movable body by receiving a radio control signal connected to the mentioned ultrasonic wave sensor drive circuit.

10. A movable body speed measuring system as claimed in claim 9, wherein the mentioned radio control reception control part is connected to an aerial wire receiving a radio control signal through a reception part demodulating a radio control signal and also connected to a driving part moving a movable body.

11. A movable body speed measuring system as claimed in claim 9, wherein the mentioned calculation part is further connected to a radio control transmission control part transmitting a radio control signal for controlling a movable body.

12. A movable body speed measuring system as claimed in claim 11, wherein the mentioned radio control transmission control part is further connected to an input part for operating a movable body to a random state, a storage part for storing the information received from a calculation part and a transmission part for generating a control signal, and the mentioned transmission part is connected to an aerial wire.

13. A movable body speed measuring system as claimed in claim 2, wherein the mentioned ultrasonic wave sensor output part has directivity in more than one particular directions.

14. A movable body speed measuring system as claimed in claim 2, wherein the mentioned ultrasonic wave sensor output part does not have directivity.

15. A movable body speed measuring method wherein:
an ultrasonic wave signal output part mounted on a movable body produces and outputs an ultrasonic wave signal of a particular frequency;
an ultrasonic wave signal reception part receives the outputted ultrasonic wave signal;
a determination part determines the difference between the frequency of the ultrasonic wave signal received by the ultrasonic wave signal reception part and the particular frequency;
a calculation part calculates the speed of the movable body from a signal of the determination difference; and
a display part displays a result of the calculation.

16. A radio controlled movable toy wherein an ultrasonic wave signal output part as claimed in claim 1 is mounted on a radio controlled movable body; and an ultrasonic wave signal reception part, a determination part, a calculation part and a display part as claimed in claim 1 are mounted on a transmitter for radio control.
